(19) United States
(12) Patent Application Publication
(10) Pub. No.: US 2008/0251382 A1
(43) Pub. Date: Oct. 16, 2008

(54) SEPARATION AND EXTREME SIZE-FOCUSING OF NANOPARTICLES THROUGH NANOCHANNELS BASED ON CONTROLLED ELECTROLYTIC PH MANIPULATION

(76) Inventors: Sang M. Han, Albuquerque, NM (US); Youn-Jin Oh, Albuquerque, NM (US); Danny Bottenus, Richland, WA (US); Cornelius F. Ivory, Pullman, WA (US)

Correspondence Address: MH2 TECHNOLOGY LAW GROUP, LLP, 1951 KIDWELL DRIVE, SUITE 550, TYSONS CORNER, VA, 22182, US

(21) Appl. No.: 12/100,841

(22) Filed: Apr. 10, 2008

Related U.S. Application Data
(60) Provisional application No. 60/922,676, filed on Apr. 10, 2007.

(51) Int. Cl. G01N 27/26; G01N 27/00; B03C 5/00

(52) U.S. Cl. 204/554; 204/601; 204/403.01

(57) ABSTRACT

Accordance to various embodiments, there are methods of separating molecules, devices, and method of making the devices. The method of separating molecules can include providing a nanofluidic device including a plurality of nanochannels on a top surface of a substrate, wherein each of the plurality of nanochannels has a first end and a second end and extends from the top surface into the substrate. The nanofluidic device can also include a dielectric layer disposed over each of the plurality of nanochannels, an inlet at the first end of the plurality of nanochannnels, an outlet at the second end of the plurality of nanochannels, and an optically transparent cover disposed over the plurality of nanochannels to form a seal. The method of separating molecules can further include providing a solution in the plurality of nanochannels through the inlet and creating a longitudinal pH gradient along each of the plurality of nanochannels.

### CROSS-REFERENCE TO RELATED APPLICATIONS

This application claims priority to U.S. Provisional Patent Application Ser. No. 60/922,676 filed on Apr. 10, 2007, the disclosure of which is incorporated in its entirety by reference herein.

### FIELD OF THE INVENTION

The present invention relates to nanofluidic separation devices and methods of separating molecules and, more particularly, relates to separation and extreme size-focusing of nanoparticles through nanochannels based on manipulation of pH gradient by controlled electrolysis.

### BACKGROUND OF THE INVENTION

In order to characterize and understand protein function and regulation, proteins must be first systemically separated and detected. The most common technique for protein separations is gel electrophoresis. Currently, 1-D and 2-D polyacrylamide gel electrophoresis (PAGE) setup is commercially available and is widely used as a standard technique. Despite its wide usage, however, the PAGE technique has its own limitations, such as large amount of required sample, low reproducibility, breakdown under high electric field, and low dynamic range.

Thus, there is a need to overcome these and other problems of the prior art to provide an integrated nanofluidic device that serves as an analytical tool and as a separation medium not only for proteins and other biomolecules, but also for nanoparticles.

### SUMMARY OF THE INVENTION

According to various embodiments, there is a device for separating molecules including a plurality of nanochannels on a top surface of a substrate, wherein each of the plurality of nanochannels has a first end and a second end and extends from the top surface into the substrate forming two sidewalls. The device can also include a dielectric layer disposed over each of the plurality of nanochannels, an inlet at the first end of the plurality of nanochannels, an outlet at the second end of the plurality of nanochannels and an optically transparent cover disposed over the plurality of nanochannels.

In accordance with various embodiments, there is a method of separating molecules. The method can include providing a nanofluidic device including a plurality of nanochannels on a top surface of a substrate, wherein each of the plurality of nanochannels has a first end and a second end and extends from the top surface into the substrate. The nanofluidic device can also include a dielectric layer disposed over each of the plurality of nanochannels, an inlet at the first end of the plurality of nanochannels, an outlet at the second end of the plurality of nanochannels, and an optically transparent cover disposed over the plurality of nanochannels to form a seal. The method of separating molecules can further include providing a solution in the plurality of nanochannels through the inlet and creating a longitudinal pH gradient along each of the plurality of nanochannels.

According to various embodiments, there is a method of making a nanofluidic device. The method can include forming a plurality of nanochannels on a top surface of a substrate, wherein each of the plurality of nanochannels has a first end and a second end and extends from the top surface into the substrate forming two sidewalls. The method can also include forming a layer of a dielectric material over each sidewall and bottom of the plurality of nanochannels, forming an inlet at the first end of the plurality of nanochannels, forming an outlet at the second end of the plurality of nanochannels, and sealing the plurality of nanochannels with an optically transparent cover.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1A shows a schematic illustration of an exemplary device for separating molecules, according to various embodiments of the present teachings.

FIG. 1B depicts a top view of a substrate of the exemplary device shown in FIG. 1A in accordance with various embodiments of the present teachings.

FIG. 1C depicts a side view of a substrate of the exemplary device shown in FIG. 1A in accordance with various embodiments of the present teachings.

FIG. 1D depicts a magnified partial cross-sectional view of a portion of the exemplary device shown in FIG. 1A in accordance with various embodiments of the present teachings.

FIG. 2 depicts an exploded view of another exemplary device for separating molecules, according to various embodiments of the present teachings.

FIG. 3 shows a schematic illustration of another exemplary device for separating molecules in accordance with various substrate of the exemplary device of FIG. 1A embodiments of the present teachings.

FIGS. 4A-4J schematically illustrate a method of making a nanofluidic device in accordance with exemplary embodiments of the present teachings.

### DESCRIPTION OF THE EMBODIMENTS

In the following description, reference is made to the accompanying drawings that form a part thereof and in which are shown by way of illustration specific exemplary embodiments in which the invention may be practiced. These embodiments are described in sufficient detail to enable those skilled in the art to practice the invention and it is to be understood that other embodiments may be utilized and that changes may be made without departing from the scope of the invention. The following description is, therefore, not to be taken in a limited sense.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less that 10” can assume negative values, e.g. −1, −2, −3, −10, −20, −30, etc.

As used herein, the term “multiple internal reflection crystal” is synonymous and used interchangeably with “MIR crystal”, “ATR crystal”, and “attenuated total reflection crystal”.

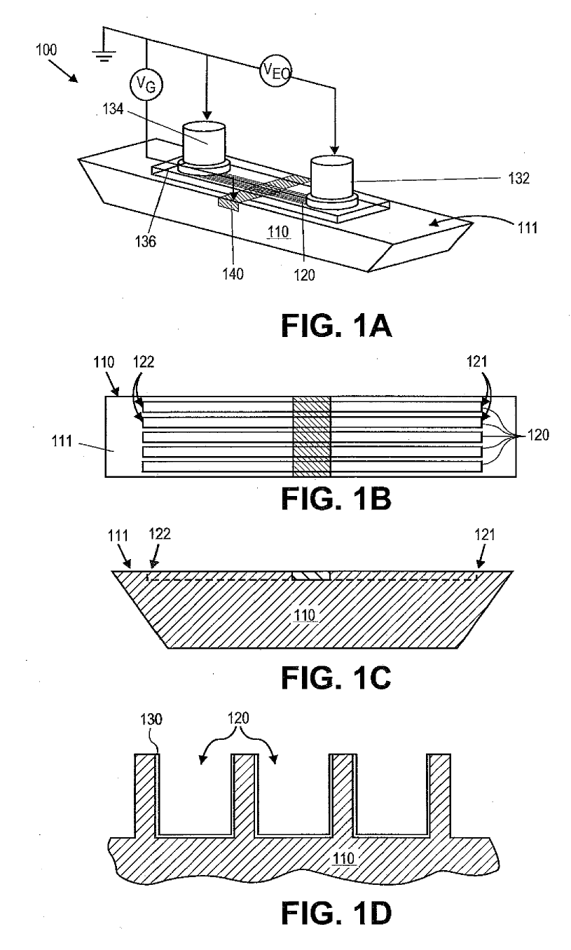

FIGS. 1A, 2, and 3 depict exemplary devices 100, 200, 300 for separating molecules, according to various embodiments of the present teachings. FIG. 1A shows a schematic illustration of an exemplary device 100 for separating molecules, including a substrate 110 including a top surface 111. The substrate 110 can be formed of a material, such as, for example, Si, Ge, GaAs, ZnS, ZnSe, and KRS-5. In some embodiments, the substrate 110 can include a multiple internal reflection (MIR) crystal that is substantially transparent to at least a portion of mid-infrared light (about 2.5 μm to about 16 μm). The substrate 110 can be of any suitable shape. However, the substrate 110 including an MIR crystal can be, for example, a trapezoid or a parallelogram, as seen from the side view, as shown in FIG. 1C. Referring back to the device 100 for separating molecules, the device 100 can also include a plurality of nanochannels 120 on the top surface 111 of the substrate 110, wherein each of the plurality of nanochannels 120 has a first end 121 and a second end 122 and extends from the top surface into the substrate 110, as shown in FIGS. 1A-1D. In various embodiments, each of the plurality of nanochannels 120 can be rectangular in shape, as shown in FIGS. 1B, 1C, and 1D. However, nanochannels 120 can be any suitable shape. In some embodiments, each of the plurality of nanochannels 120 can be separated by a section of the substrate 110 such that a width of each of the plurality of nanochannels 120 can be greater than the section of the substrate 110 in between the nanochannels 120, as shown in FIGS. 1B and 1D. In other embodiments, each of the plurality of nanochannels 120 can be separated by a section of the substrate 110 such that a width of each of the plurality of nanochannels 120 can be the same or less than the section of the substrate 110 in between the nanochannels 120. In some embodiments, each of the plurality of nanochannels 120 can have a width of about 100 nm or less. In other embodiments, each of the plurality of nanochannels 120 can have a depth of about 400 nm or more. U.S. Pat. No. 7,200,311 describes in detail how to increase the detection sensitivity of the substrate 110 including an MIR crystal, the disclosure of which is incorporated by reference herein in its entirety.

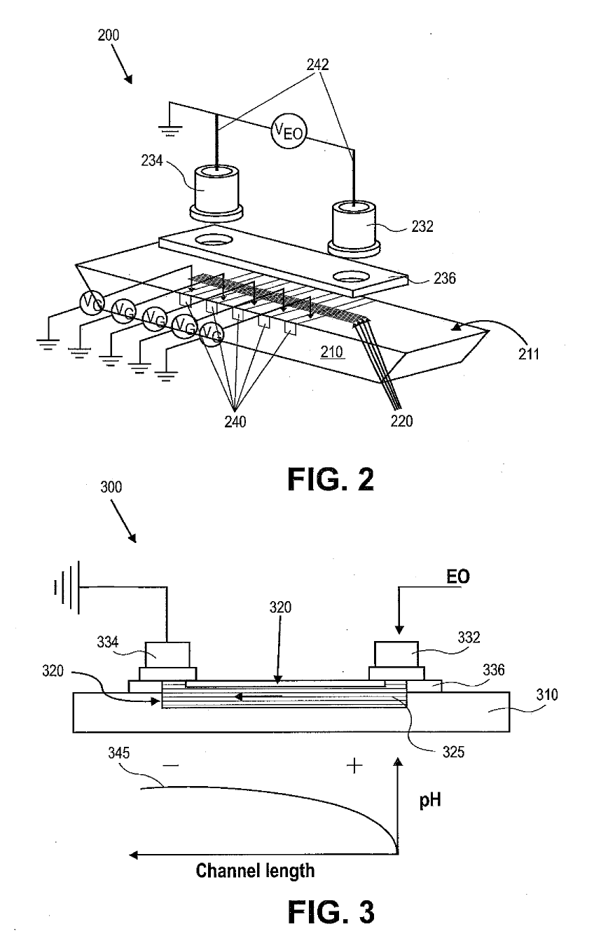

As shown in FIG. 1D, the device 100 can also include a dielectric layer 130 disposed over a surface of each of the plurality of nanochannels 120. In some embodiments, the dielectric layer 130 can be over one or more sidewalls and bottom of the nanochannel 120, as shown in FIG. 1D. Any suitable dielectric material can be used for the dielectric layer 130, including, but not limited to, silicon oxide (SiO₂), silicon nitride (Si₃N₄), aluminum oxide (Al₂O₃), and hafnium oxide (HfO₂). The device 100 can further include an inlet 132 at the first end 121 of the plurality of nanochannels 120, an outlet 134 at the second end 122 of the plurality of nanochannels 120, and an optically transparent cover 136 disposed over the plurality of nanochannels 120, as shown in FIG. 1A. Any suitable material can be used for the optically transparent cover 136, including, but not limited to, Pyrex®, quartz, and polydimethylsiloxane (PDMS). In some embodiments, there is no dielectric layer 130 over the surface of the optically transparent cover 136 disposed over the plurality of nanochannels 120. In various embodiments, the device 100, as shown in FIG. 1A-1D can also include one or more gates 140 disposed in the substrate 110 across the plurality of nanochannels 120, wherein each of the one or more gates 140 can be a doped region. Any suitable material can be used to form the doped region in the one or more gates 140, including, but not limited to, boron, arsenic, sulfur, selenium, tellurium, phosphorus, antimony, magnesium, zinc, cadmium. In various embodiments, the one or more gates 140 and the dielectric layer 130 can be disposed such that a zeta potential (ζ-potential) on the dielectric layer 130 can be controlled by the application of an electrical potential to the one or more gates 140. FIG. 2 depicts an exploded view of another exemplary device 200 for separating molecules including multiple gates 240 disposed in the substrate 210 across the plurality of nanochannels 220. In various embodiments, one or more gates 240 across each of the plurality of nanochannels 220 can be individually addressable. The device 200 can also include electrodes 242 at the inlet 232 and the outlet 234, as shown in FIG. 2. Any suitable material can be used for the electrodes 242, such as, for example, platinum. The device 200 can also include an optically transparent cover 236 disposed over the plurality of nanochannels 220 on the top surface 211 of the substrate 210. In some embodiments, the one or more gates 140, 240 and the dielectric layer 130 can be disposed such that a pH gradient 345 can be created along a length of each of the plurality of nanochannels 120, 220, 320 in a solution 325 in the plurality of nanochannels 120, 220, 320, as shown in FIG. 3. In other embodiments, a pH gradient 345 along the plurality of nanochannels 120, 220, 320 can be created in a solution 325 in the plurality of nanochannels 120, 220, 320 by controlled electrolysis at the electrodes 242 at the inlet 132, 232, 332 and the outlet 134, 234, 334, as shown in FIG. 3. In various embodiments, the exemplary devices 100, 200, 300 for separating molecules can be coupled to a multiple internal reflection Fourier transform infrared spectrometer (MIR-FTIR) (not shown) enabling in situ on-line analysis of molecules and/or nanoparticles in the nanochannels 120, 220, 320, using multiple internal reflection Fourier transform infrared spectroscopy (MIR-FTIRS). In some embodiments, the exemplary devices 100, 200, 300 for separating molecules can be coupled to a scanning laser confocal fluorescence microscope (SL-CFM) (not shown) enabling in situ, on-line analysis of molecules and/or nanoparticles in the nanochannels 120, 220, 320, using scanning laser confocal fluorescence microscopy.

According to various embodiments, there is a method of separating molecules. The method can include providing a nanofluidic device 100, 200, 300, as shown in FIGS. 1A, 2, and 3. The nanofluidic device 100, 200, 300 can include a plurality of nanochannels 120, 220, 320 on a top surface 111, 211 of a substrate 110, 210, 310, wherein each of the plurality of nanochannels 120, 220, 320 can have a first end 121 and a second end 122 and can extend from the top surface 111, 211 into the substrate 110, 210, 310. The nanofluidic device 100, 200, 300 can also include a thin layer 130 of a dielectric material disposed over a surface of each of the plurality of nanochannels 120, 220, 320, as shown in FIG. 1D, an inlet 132, 232, 332 at the first end 121 of the plurality of nanochannels 110, 220, 320, an outlet 134, 234, 334 at the second end 122 of the plurality of nanochannels 110, 220, 320, and an optically transparent cover 136, 236, 336 disposed over the plurality of nanochannels 110, 220, 320 to form a seal. In various embodiments, the nanofluidic device 100, 200, 300 can include one or more gates 140, 240 disposed in the substrate 110, 210, 310 across the plurality of nanochannels 110, 220, 320, wherein each of the one or more gates 140, 240 can be a doped region. In some embodiments, the provided nanofluidic device 100, 200, 300 can further include an electrode 242 at each of the inlet 132, 232, 332 and the outlet 134, 234, 334, as shown in FIG. 2. Referring back to the method of separating molecules, the method can further include providing a solution 325 in the plurality of nanochannels 320 through the inlet 332 and creating a longitudinal pH gradient 345 along each of the plurality of nanochannels 320, as shown in FIG. 3. In some embodiments, the provided solution 325 can include nanoparticles having functionalized organic ligands. In other embodiments, the provided solution 325 can include biomolecules, such as, for example proteins, DNA, organelle, and lipid bilayers that can include plant and/or animals material. In some embodiments, the step of creating a longitudinal pH gradient 345 along the plurality of nanochannels 120, 220, 320 can include applying a DC potential drop between the inlet 132, 232, 332 and the outlet 134, 234, 334, as shown in FIGS. 1A, 2, and 3. In some other embodiments, the step of creating a longitudinal pH gradient 345 along the plurality of nanochannels 120, 220, 320 can include applying a DC potential, with respect to the ground, to the one or more gates 140, 240 as shown in FIGS. 1A and 2. The expression “longitudinal pH gradient” as used herein means that a pH gradient along a length of the nanochannel 120, 220, 320. In some cases, the longitudinal pH gradient can exist starting from the first end 121 and ending at the second end 122. In other cases, the longitudinal pH gradient can exist in a small region between the first end 121 and the second end 122.

In some embodiments, the step of providing nanofluidic device can also include providing electrodes 242 at the inlet 232 and the outlet 234, as shown in FIG. 2. In various embodiments, the step of creating a longitudinal pH gradient 345 along the plurality of nanochannels 120, 320, 330 can include initiating electrolytic reactions at the electrodes 242. In some embodiments, the method of separating molecules can further include separating biomolecules in a solution by isoelectric focusing with the longitudinal pH gradient along the plurality of nanochannels. In other embodiments, the method of separating molecules can also include separating nanoparticles by size using isoelectric focusing with the longitudinal pH gradient along the plurality of nanochannels. In some embodiments, the nanoparticles can be separated such that a standard deviation of size distribution can be less than about 10%, and in some cases less than about 5%.

In various embodiments, the flow of the solution 325 can be controlled using electroosmosis (EO), by applying a longitudinal electrical potential (V_{EO}) along the nanochannels 320. To move the solution 325 along the nanochannels 320 by electroosmosis, two different electrical potentials can be applied to the inlet 332 and outlet 334, as shown in FIGS. 1A, 2, and 3. The flow control can be enhanced by an order of magnitude in speed with an isolated gate 140 surrounding a short longitudinal segment of the nanochannels 120, as shown in FIG. 1A. Upon contacting an electrolyte solution 325, the surface of the dielectric layer 130, such as SiO₂, can assume a varying amount of either positive or negative surface charge according to its isoelectric point (pI_{SiO}_{₂}˜3.7). Typically, the SiO₂ surface is negatively charged in aqueous solutions, since hydroxyl groups (Si—OH) on the SiO₂ surface are deprotonated to produce Si—O when the solution pH is above ˜3.7. The polarity and magnitude of this surface charge and therefore the ζ-potential (zeta potential) can then be adjusted by an electric potential (V_{G}) applied to the nanochannel 120, 320. The modulation of ζ-potential in this manner allows manipulation of flow speed and direction of electroosmosis. The flow speed accelerates when a negative potential (V_{G}<0) is applied to the nanochannel 120, 320 to lower the ζ-potential. Conversely, the flow speed decelerates, or the flow direction is reversed when a positive potential (V_{G}>0) is applied to the nanochannel 120, 320 to increase the ζ-potential. This flow control is analogous to the current control by the gate in conventional metal oxide semiconductor field effect transistors (MOSFETs).

In various embodiments, the method of separating molecules can further include in-situ monitoring of the molecules being separated in the solution by one or more of multiple internal reflection Fourier transform infrared spectroscopy (MIR-FTIR) and scanning laser confocal fluorescence microscopy (SL-CFM). In some embodiments, the step of in-situ monitoring can further include directing an infrared light to enter a first side of the substrate 110, 210, 310 such that the infrared light reflects more than once from the top surface 111 of the substrate 110, 210, 310, wherein the substrate 110 includes a multiple internal reflection crystal that is substantially transparent to mid-infrared light. The step of in-situ monitoring can further include detecting the infrared light after the infrared light exits from a second side of the substrate 110, 210, 310 to determine infrared absorbance from the infrared light absorbing materials in the solution 325. In certain embodiments, the step of detecting the infrared light after the infrared light exits a second side of the substrate 110, 210, 310 to determine infrared absorbance from the infrared light absorbing materials in the solution 325 can include using Fourier transform infrared spectroscopy (FTIRS). In various embodiments, the method of separating molecules can also include optical monitoring of the solution through the optically transparent cover using scanning laser confocal fluorescence microscopy (SL-CFM).

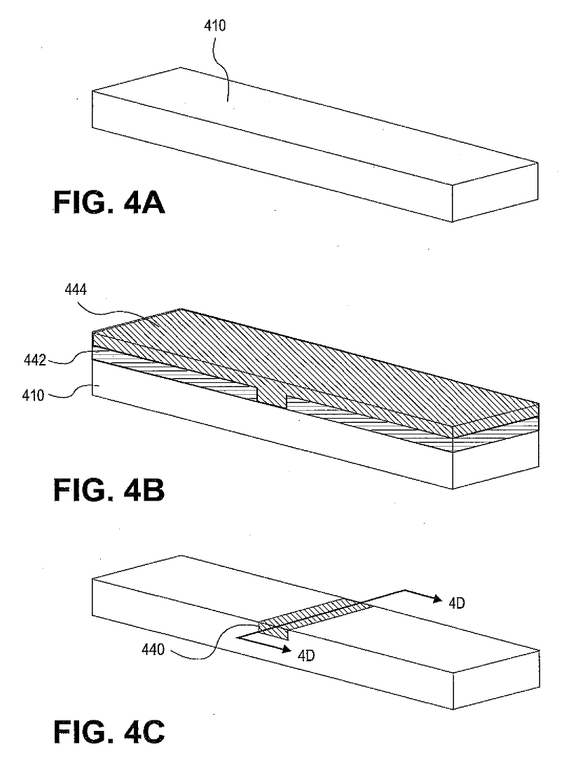

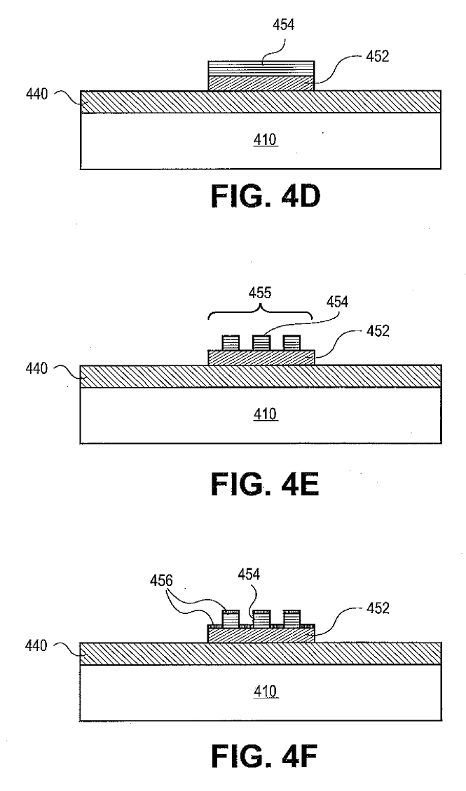

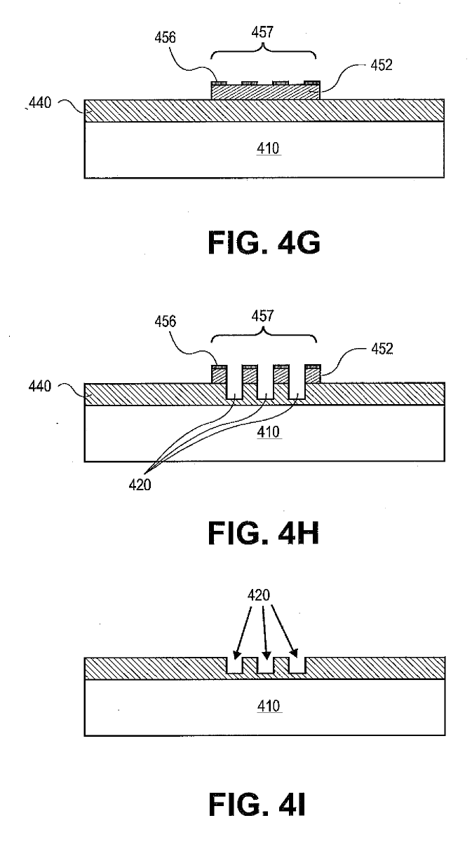

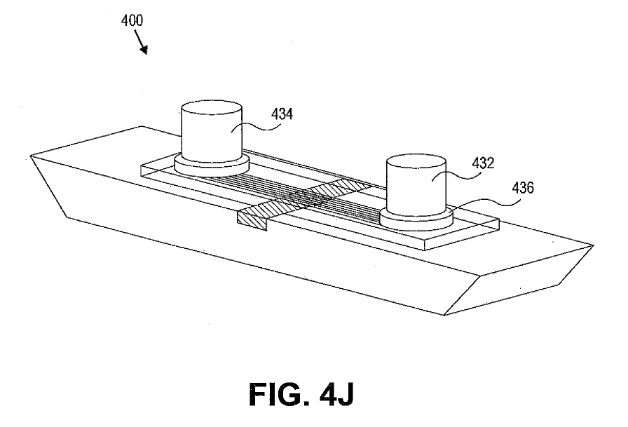

FIGS. 4A-4J schematically illustrate a method of making a nanofluidic device 400. The method can include providing a substrate 410 including a top surface as shown in FIG. 4A. In some embodiments, the substrate 410 can be a double-side-polished MIR crystal. In some embodiments, the method can include forming one or more gates 440 in the substrate 410 across the plurality of nanochannels 420, as shown in FIGS. 4B and 4C. Any suitable method can be used for forming one or more gates 440. In some embodiments, the step of forming one or more gates can include forming a mask layer 442 over the substrate 410, such as, for example, growing a 100 nm thick thermal SiO₂ layer over a silicon substrate. In various embodiments, the mask layer 442 can have a thickness from about 75 nm to about 150 nm. The step of forming one or more gates 440 can further include etching one or more sections of the mask layer 442 to expose the underlying substrate 410 to allow dopant diffusion. A spin-on dopant 444, such as, for example a boron spin-on dopant ACCUSPIN® B-150 (Honeywell, Tempe, Ariz.) can be spin-coated on the entire top surface, as shown in FIG. 4B. The dopant diffusion can then be carried out for about 30 minutes to about 90 min at about 900° C. to about 1200° C. in an O₂—N₂ environment, which can result in the formation of a diffusion layer 440 having a depth of about 0.9 μm to about 1.5 μm and a dopant level on the order of 10²⁰ cm⁻³. After the thermal diffusion, the spin-on dopant 444 and the mask layer 442 can be removed, as shown in FIG. 4C. In the exemplary case, where the mask layer 442 includes a thermal SiO2, the spin-on dopant 444 and the mask layer 442 can be stripped using a buffered HF solution.

The method of making a nanofluidic device 400 can also include forming a plurality of nanochannels 420 on the top surface of the substrate 410, as shown in FIGS. 4D-4I. Nanochannels 420 can be formed by, for example, etching. According to various embodiments, nanochannels 420 can be formed by plasma etching using, for example, a fluorocarbon plasma, a Cl₂/HBr plasma, or an He/SF₆ plasma. In various embodiments, nanochannels 420 can be formed using interferometric lithography followed by etching. For the interferometric lithography (IL), the substrate 410 can be coated with an anti-reflective coating (ARC) layer 452 and a layer of photoresist (PR). 454, as shown in FIG. 4D. FIGS. 4D-41 shows a cross sectional view of the substrate shown in FIG. 4C. The PR/ARC stack can then be exposed to UV laser to create the nanochannel patterns 455, using interferometric lithography (IL). After the IL step, the PR can be developed to form a nanochannel Mask 455, exposing the underlying ARC, as shown in FIG. 4E. A metal layer 456, such as, for example, chrome, can then be deposited on the developed PR nanochannels, as shown in FIG. 4F. The Cr-PR stacks can then be removed by lift-off in acetone, leaving Cr-ARC-covered nanochannel pattern 457, as shown in FIG. 4G. The Cr-ARC-covered nanochannel pattern 457 can serve as a hard mask that yields a negative image of the previously developed PR patterns 455. Any suitable plasma, such as, for example, a fluorocarbon plasma, a Cl₂/HBr plasma, or an He/SF₆ plasma can be use to etch high-aspect-ratio nanochannels 420 in the substrate 410, as shown in FIG. 4H. The remaining Crand ARC can be removed using any suitable method, such as, for example, O₂ plasma, as shown in FIG. 4I.

The method of making a nanofluidic device 400 can further include forming a layer 130 of a dielectric material over a surface each of the plurality of nanochannels 120, 220, 320, 420 to insert an electrically insulating layer between the nanochannel walls and the fluid 325 and to narrow the nanochannel width to a desired level. The method can further include forming an inlet 432 at the first end of the plurality of nanochannels 420, forming an outlet 434 at the second end of the plurality of nanochannels 420, and sealing the plurality of nanochannels 420 with an optically transparent cover 436, as shown in FIG. 4J. In various embodiments, the step of sealing the plurality of nanochannels 420 with an optically transparent cover 436 can include anodically bonding a Pyrex® cover with the substrate 410 by applying about 1 kV between the substrate 410 and the Pyrex cover 436 at about 380° C.

While the invention has been illustrated with respect to one or more implementations, alterations and/or modifications can be made to the illustrated examples without departing from the spirit and scope of the appended claims. In addition, while a particular feature of the invention may have been disclosed with respect to only one of several implementations, such feature may be combined with one or more other features of the other implementations as may be desired and advantageous for any given or particular function. Furthermore, to the extent that the terms “including”, “includes”, “having”, “has”, “with”, or variants thereof are used in either the detailed description and the claims, such terms are intended to be inclusive in a manner similar to the term “comprising.”

As used herein, the term “one or more of” with respect to a listing of items such as, for example, A and B, means A alone, B alone, or A and B.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A device for separating molecules comprising:
a plurality of nanochannels on a top surface of a substrate, wherein each of the plurality of nanochannels has a first end and a second end and extends from the top surface into the substrate forming two sidewalls;
a dielectric layer disposed over a surface of each of the plurality of nanochannels;
an inlet at the first end of the plurality of nanochannels;
an outlet at the second end of the plurality of nanochannels; and
an optically transparent cover disposed over the plurality of nanochannels.

2. The device for separating molecules of claim 1 further comprising one or more gates disposed in the substrate across the plurality of nanochannels, wherein each of the one or more gates is a doped region.

3. The device for separating molecules of claim 2, wherein one or more gates across each of the plurality of nanochannels are individually addressable.

4. The device for separating molecules of claim 2, wherein the one or more gates and the dielectric layer are disposed such that a zeta potential on the dielectric layer can be controlled by the application of an electrical potential to the one or more gates.

5. The device for separating molecules of claim 1 further comprising electrodes at the inlet and the outlet.

6. The device of claim 5, wherein a pH gradient along a length of each of the plurality of nanochannels is created in a solution in the plurality of nanochannels by controlled electrolysis at the electrodes at the inlet and the outlet.

7. The device for separating molecules of claim 1, wherein the substrate comprises one of Si, Ce, GaAs, ZnS, ZnSe, and KRS-5.

8. The device for separating molecules of claim 1, wherein the substrate comprises a multiple internal reflection (MIR) crystal that is substantially transparent to mid-infrared light.

9. The device for separating molecules of claim 8, wherein the device is coupled to a multiple internal reflection Fourier transform infrared spectrometer (MIR-FTIRS).

10. The device for separating molecules of claim 1, wherein the device is coupled to a scanning laser confocal fluorescence microscope (SL-CFM).

11. The device for separating molecules of claim 1, wherein each of the plurality of nanochannels has a width of about 100 nm or less.

12. The device for separating molecules of claim 1, wherein each of the plurality of nanochannels has a depth of about 400 nm or more.

13. A method of separating molecules comprising:
providing a nanofluidic device comprising:
a plurality of nanochannels on a top surface of a substrate, wherein each of the plurality of nanochannels has a first end and a second end and extends from the top surface into the substrate;
a dielectric layer disposed over a surface of each of the plurality of nanochannels;
an inlet at the first end of the plurality of nanochannels;
an outlet at the second end of the plurality of nanochannels; and
an optically transparent cover disposed over the plurality of nanochannels to form a seal.
providing a solution in the plurality of nanochannels through the inlet; and
creating a longitudinal pH gradient along each of the plurality of nanochannels.

14. The method of claim 13, wherein the provided nanofluidic device further comprises one or more gates disposed in the substrate across the plurality of nanochannels, wherein each of the one or more gates is a doped region.

15. The method of claim 14, wherein the step of creating a longitudinal pH gradient along each of the plurality of nanochannels comprises at least one of applying a DC potential drop between the inlet and the outlet and applying a DC potential, with respect to the ground, to the one or more gates.

16. The method of claim 13, wherein the provided nanofluidic device further comprises an electrode at each of the inlet and the outlet.

17. The method of claim 16, wherein the step of creating a longitudinal pH gradient along each of the plurality of nanochannels comprises initiating electrolytic reactions at the electrodes.

18. The method of claim 13 further comprising in-situ monitoring of the molecules being separated in the solution by one or more of multiple internal reflection Fourier transform infrared spectroscopy (MIR-FTIR) and scanning laser confocal fluorescence microscopy (SL-CFM).

19. The method of claim 18 further comprising:
directing an infrared light to enter a first side of the substrate such that the infrared light reflects more than once from the top surface of the substrate, wherein the substrate comprises a multiple internal reflection (MIR) crystal that is substantially transparent to mid-infrared light; and
detecting the infrared light after the infrared light exits from a second side of the substrate to determine infrared absorbance from the infrared light absorbing materials in the solution.

20. The method of claim 18 further comprising optical monitoring of the solution through the optically transparent cover using scanning laser confocal fluorescence microscopy (SL-CFM).

21. The method of claim 13 further comprising separating biomolecules in a solution by isoelectric focusing with the longitudinal pH gradient along the plurality of nanochannels.

22. The method of claim 13, wherein the provided solution comprises nanoparticles having functionalized organic ligands.

23. The method of claim 22 further comprising separating nanoparticles by size using isoelectric focusing with the longitudinal pH gradient along the plurality of nanochannels.

24. A method of making a nanofluidic device, the method comprising:
forming a plurality of nanochannels on a top surface of a substrate, wherein each of the plurality of nanochannels has a first end and a second end and extends from the top surface into the substrate forming two sidewalls;
forming a layer of a dielectric material over a surface of each of the plurality of nanochannels;
forming an inlet at the first end of the plurality of nanochannels;
forming an outlet at the second end of the plurality of nanochannels; and
sealing the plurality of nanochannels with an optically transparent cover.

25. The method of claim 24 further comprising forming one or more gates in the substrate across the plurality of nanochannels, wherein each of the one or more gates is a doped region.

26. The method of claim 24, wherein the step of forming a plurality of nanochannels on the top surface of the substrate comprises:
forming a nanochannel pattern on a photoresist layer over the top surface of the substrate using interferometric lithography;
developing the photoresist layer; and
forming a plurality of nanochannels on the top surface of the substrate using plasma etching.
